(19) United States
(12) Patent Application Publication
(10) Pub. No.: US 2025/0206401 A1
(43) Pub. Date: Jun. 26, 2025

(54) Bracket for a Mudguard

(71) Applicant: Jalco Industry Co., Ltd., Huatan Township (TW)

(72) Inventor: Han-Tsung Chen, Huatan Township (TW)

(21) Appl. No.: 18/967,856

(22) Filed: Dec. 4, 2024

(30) Foreign Application Priority Data
Dec. 25, 2023 (TW) 112214142

(51) Int. Cl. B62J 15/02

(52) U.S. Cl. CPC B62J 15/02

(57) ABSTRACT

A bracket includes a U-shaped element, two collars and two nuts. The U-shaped element includes an arched section formed between two branches. The arched section of the U-shaped element is attached to a mudguard. The collars are respectively secured to the branches of the U-shaped element. The collars are operable to receive two sections of a skewer. The nuts are operable for engagement with two threaded sections of the skewer.

### BACKGROUND OF INVENTION

### 1. Field of Invention

The present invention relates to a mud of a bicycle and, more particularly, to a bracket for a mudguard.

### 2. Related Prior Art

A mudguard is used above a front or rear wheel of a bicycle to fend water, mud and/or gravel. Thus, a rider is protected from such water, mud and/or gravel. Moreover, a bystander is protected from such water, mud and/or gravel. Furthermore, a brake, a derailleur and/or a lamp is protected from such water, mud and/or gravel.

Conventionally, the mudguard is attached to a fork or a chain-stay or seat-stay by two rods. Each of the rods includes an upper end attached to a portion of the mudguard and a lower end attached to a lower end of one of two branches of the fork or the chain-stay or seat-stay. Another portion of the mudguard is attached to a middle portion of the chain-stay or seat-stay. However, the rods often provide inadequate support to the mudguard so that the mudguard can easily be biased and/or deformed.

Therefore, the present invention is intended to obviate or at least alleviate the problems encountered in the prior art.

### SUMMARY OF INVENTION

It is the primary objective of the present invention to a provide a robust bracket for a mudguard.

To achieve the foregoing objective, the bracket includes a U-shaped element, two collars and two nuts. The U-shaped element includes an arched section formed between two branches. The arched section of the U-shaped element is attached to a mudguard. The collars are respectively secured to the branches of the U-shaped element. The collars are operable to receive two sections of a skewer. The nuts are operable for engagement with two threaded sections of the skewer.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a mudguard attached to a bicycle by a bracket according to the preferred embodiment of the present invention;

FIG. 2 is a perspective view of the mudguard and the bracket shown in FIG. 1;

FIG. 3 is a perspective view of the bracket shown in FIG. 2;

FIG. 4 is a cross-sectional view of the bicycle and the bracket shown in FIG. 1; and

FIG. 5 is a perspective view of another nut for engagement with a threaded section of a skewer to keep the bracket on the bicycle shown in FIG. 1.

### DETAILED DESCRIPTION OF PREFERRED EMBODIMENT

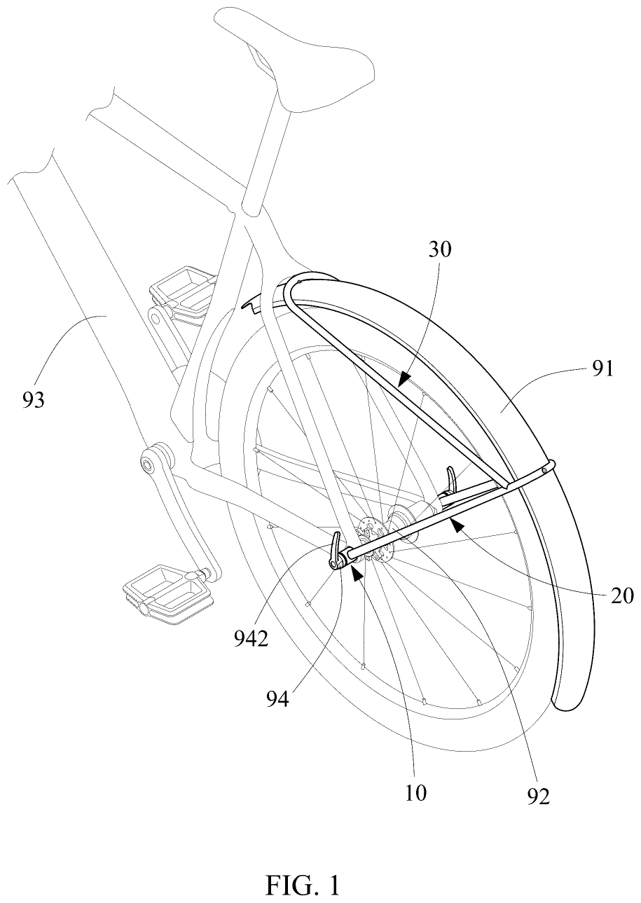

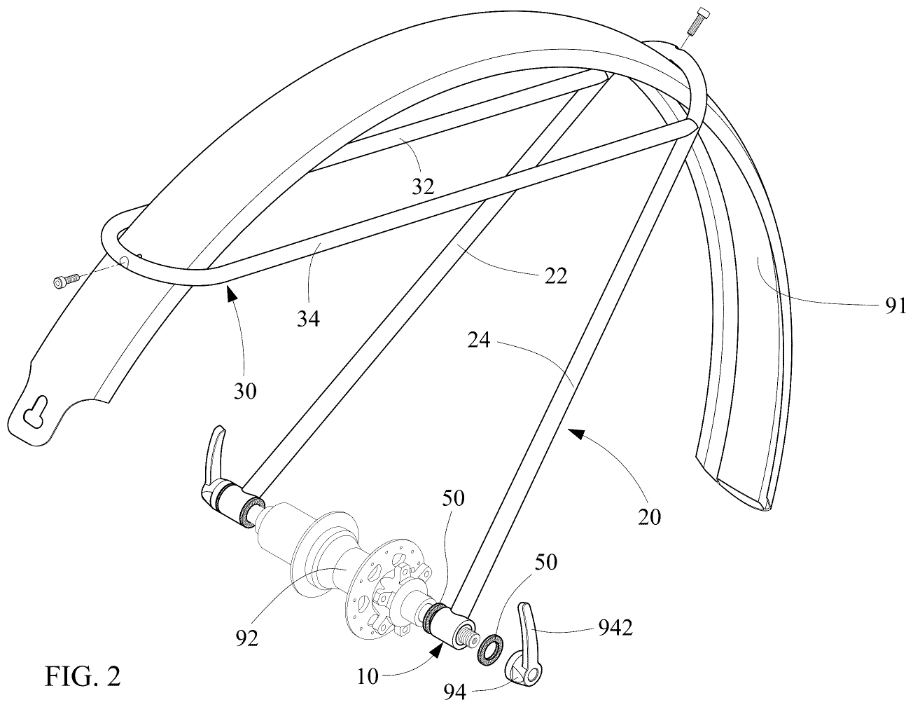

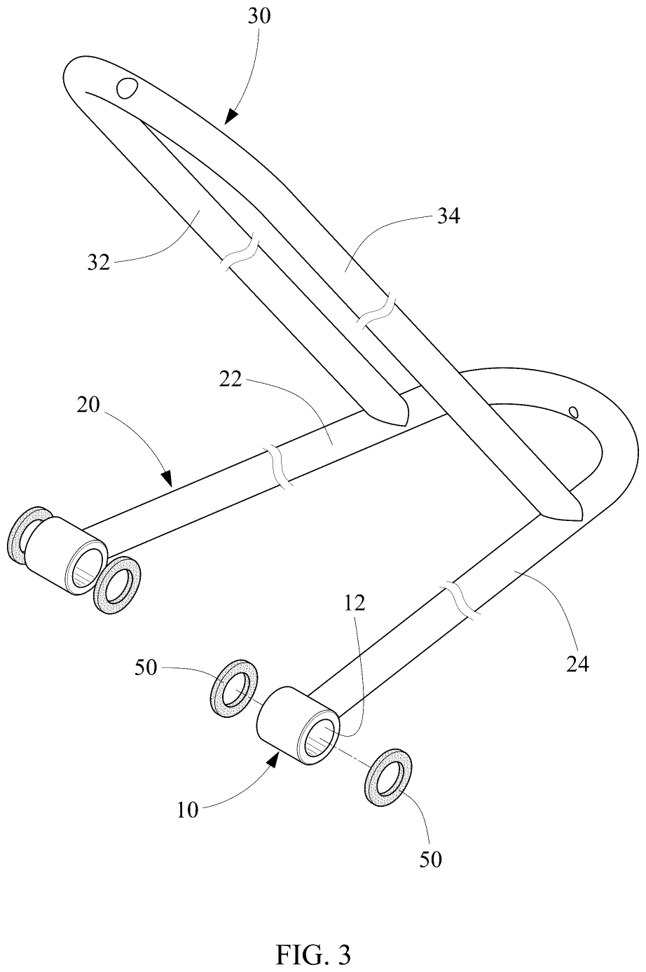

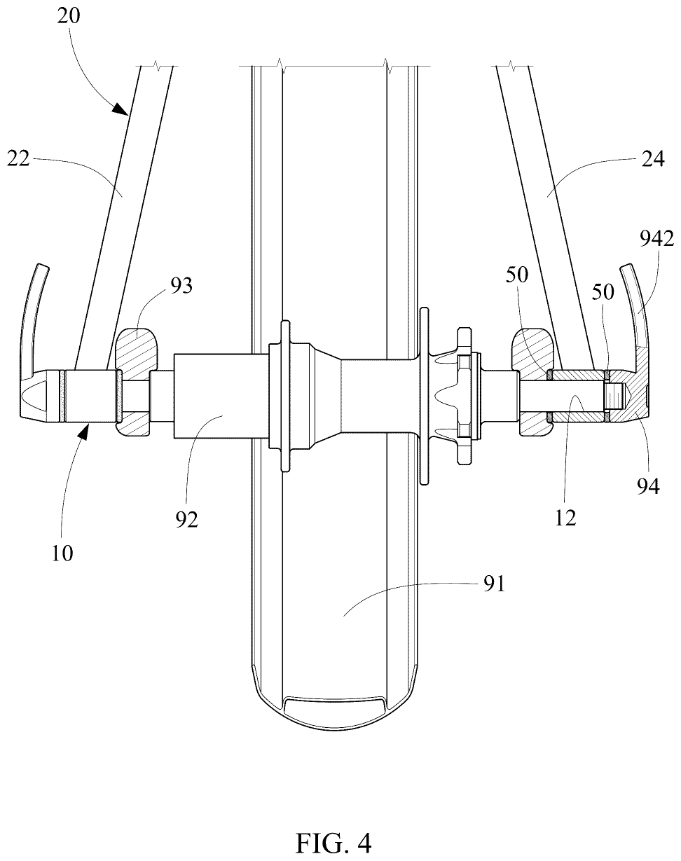

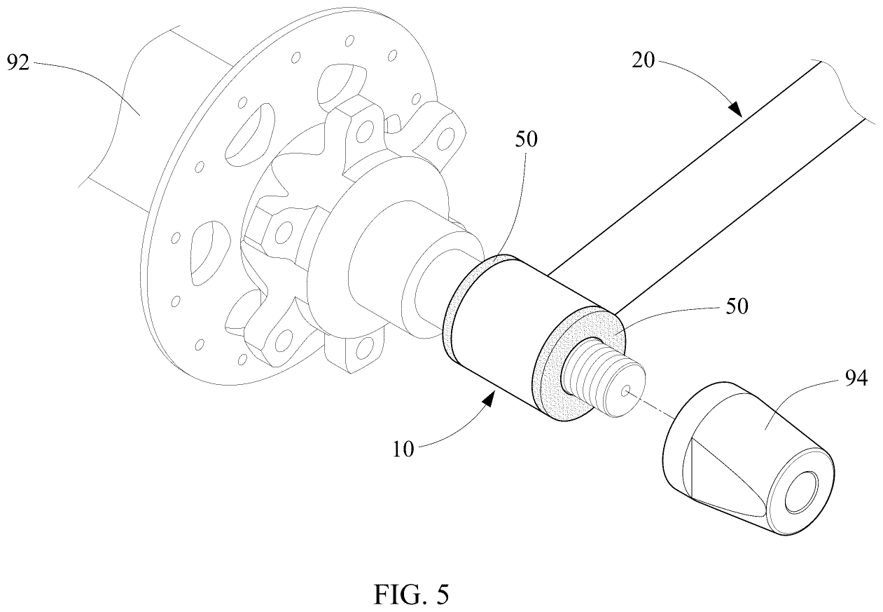

Referring to FIGS. 1 through 4, a mudguard 91 is attached to a frame 93 of a bicycle by a skewer (or “axle”) 92, two nuts 94 and a bracket according to the preferred embodiment of the present invention. The skewer 92 is used to attach a wheel to a chain-stay or seat-stay (not numbered) of the frame 93 or a fork (not shown) of the bicycle. The nuts 94 are respectively engaged with two threaded sections of the skewer 92. Each of the nuts 94 includes a lever 942 operable to rotate the nut 94. However, the lever 942 can be omitted in another embodiment (FIG. 5), i.e., each of the nuts 94 does not include any lever.

The bracket includes two collars 10 and two U-shaped elements 20 and 30. The U-shaped elements 20 and 30 are connected to each other by welding for example. The collars 10 are attached to the U-shaped element 20 by welding for example.

The U-shaped element 20 includes an arched section (not numbered) formed between two rectilinear branches 22 and 24.

The U-shaped element 30 includes an arched section (not numbered) formed between two rectilinear branches 32 and 34. The branches 32 and 34 are respectively connected to the branches 22 and 24 by welding for example. There is an angle between the branches 32 and 22. There is an identical angle between the branches 34 and 24. However, the U-shaped element 30 can be omitted in another embodiment.

Each of the collars 10 is attached to an end of one of the branches 22 and 24 by welding for example. Each of the collars 10 includes an axial aperture 12 for receiving a section of the skewer 92. Each of the collars 10 includes a side in contact with one of two branches of the chain-stay, seat-stay or fork and another side in contact with one of the nuts 94. The skewer 92 and the bracket are firmly attached to the chain-stay, seat-stay or fork for example as the nuts 94 are tightly engaged with the threaded sections of the skewer 92.

To attach the mudguard 91 to the chain-stay, seat-stay or fork by the bracket, the arched section of the U-shaped element 20 is attached to a portion of the mudguard by a screw and the arched section of the U-shaped element 30 is attached to another portion of the mudguard by another screw.

The nuts 94 are disengaged from the threaded sections of the skewer 92. Then, the skewer 92 is inserted in the collars 10 and the branches of the chain-stay, seat-stay or fork. Then, the nuts 94 are engaged with the threaded sections of the skewer 92. Thus, the mudguard 91 extends above a rear or front wheel.

Preferably, two washers 50 are used on the sides of each of the collars 10. The following description will be given to only one of the collars 10 and the corresponding washers 50. One of the washers 50 is sandwiched between one of the sides of the collar 10 and one of the branches of the chain-stay or seat-stay. The remaining one of the washers 50 is sandwiched between the remaining one of the sides of the collar 10 and the corresponding nut 94. However, the washers 50 can be omitted.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. A bracket including:
a primary U-shaped element (20) including two branches (22, 24) and an arched section formed between the branches (22, 24), wherein the arched section of the primary U-shaped element (20) is connected to a mudguard (91);
two collars (10) respectively secured to the branches (22, 24) of the primary U-shaped element (20), wherein the collars (10) receive two sections of a skewer (92); and
two nuts (94) engaged with two threaded sections of the skewer (92).

2. The bracket according to claim 1, further including a washer (50) between each of the collars (10) and the corresponding nut (94).

3. The bracket according to claim 1, further including two washers (50) respectively on two sides of each of the collars (10).

4. The bracket according to claim 1, wherein each of the nuts (94) includes a lever (942).

5. The bracket according to claim 1, further including a secondary U-shaped element (30) with two branches (32, 34) and an arched section formed between the branches (32, 34) of the secondary U-shaped element (30), wherein the branches (32, 34) of the secondary U-shaped element (30) are respectively connected to the branches (22, 24) of the primary U-shaped element (20), wherein the arched section of the secondary U-shaped element (30) is connected to the mudguard (91).

6. The bracket according to claim 5, wherein each of the branches (22, 24) of the primary U-shaped element (20) extends at an angle from the corresponding branch (32, 34) of the secondary U-shaped element (30).
